(19) United States
(12) Patent Application Publication
(10) Pub. No.: US 2009/0168234 A1
(43) Pub. Date: Jul. 2, 2009

(54) DISK DRIVE APPARATUS

(75) Inventor: Hideyuki Miyazaki, Ome-shi (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 12/248,743

(22) Filed: Oct. 9, 2008

(30) Foreign Application Priority Data
Dec. 27, 2007 (JP) 2007-338249

(51) Int. Cl. G11B 33/14

(52) U.S. Cl. 360/97.02; G9B/33.035

(57) ABSTRACT

According to one embodiment, a disk apparatus has a disk, a head, a carriage assembly, and a circulation filter provided at the corner of the base, located downstream of the head with respect to a rotating direction of the disk. A sidewall of the base has a confronting surface which continuously extends along the outer peripheral edge of the disk, is formed in an arc, and confronts with the outer peripheral edge of the disk with a gap. The base has a guide flow path 58 which is formed in the sidewall in a corner and guides an airflow to the circulation filter. The guide flow path has an inlet port and an outlet port which open to the confronting surface of the sidewall in the corner at positions away from the positions at which they confront with the outer peripheral edge of the disk.

### CROSS-REFERENCE TO RELATED APPLICATIONS

This application is based upon and claims the benefit of priority from Japanese Patent Application No. 2007-338249, filed Dec. 27, 2007, the entire contents of which are incorporated herein by reference.

### BACKGROUND

1. Field

One embodiment of the present invention relates to a disk drive apparatus having a disk-shaped recording medium that rotates at high speed.

2. Description of the Related Art

Recently, disk apparatuses such as a magnetic disk apparatus, an optical disk apparatus, and the like are widely used as an external recording apparatus and an image recording apparatus of computers.

In general, the magnetic disk apparatus, for example, a hard disk drive (HDD) has a magnetic disk, a spindle motor for driving the magnetic disk, a magnetic head for reading/writing data from and to the magnetic disk, a carriage assembly for supporting the magnetic head, a voice coil motor for driving the carriage assembly, a board unit, and the like, and these components are accommodated in an approximately hermetically sealed case. Further, the HDD has a breathing filter for removing the dust, moisture, and gas components contained in the external air flowing in from ventilation holes formed to the case and a circulation filter for capturing the dust produced in the case by the operation of movable components. The breathing filter, the circulation filter, and the carriage assembly are disposed around the magnetic disk.

It is necessary to increase the angular velocity of the magnetic disk to perform data processing at high speed in the magnetic disk apparatus described above. However, when the magnetic disk rotates at high speed, airflow is produced in the same direction as a rotating direction in which the magnetic disk rotates, and a phenomenon called disk flutter, by which the magnetic disk is vibrated, is produced by the turbulence of the airflow. Further, since wind disturbance acts on the carriage that supports the magnetic head, the carriage is displaced. In this case, since the positioning accuracy of the magnetic disk with respect to the magnetic head is deteriorated, a recording density cannot be improved.

Jpn. Pat. Appln. KOKAI Publication No. 2006-179118, for example, proposes a magnetic disk apparatus provided with a baffle wall disposed to an inlet port of a circulation filter along the outer periphery of a magnetic disk to suppress the production of a turbulent flow caused by the magnetic disk rotating at high speed. Further, Jpn. Pat. Appln. KOKAI Publication No. 2006-185486, for example, proposes a magnetic disk apparatus provided with an airflow guide for guiding the airflow passing through an annular filter from the outer periphery of a magnetic disk in the central direction of the disk.

However, in the magnetic disk apparatus disclosed in Jpn. Pat. Appln. KOKAI Publication No. 2006-179118, since the outlet side of the circulation filter largely opens to a wall surface of a base, a shroud structure is separated by the opening. Accordingly, an airflow is disturbed in the vicinity of the opening, which acts as a factor for producing disk flutter.

Further, in the magnetic disk apparatus disclosed in Jpn. Pat. Appln. KOKAI Publication No. 2006-185486, both the inlet port and the outlet port of a flow path, through which air is supplied to the annular filter, largely open to a wall surface of a base. Accordingly, a shroud structure is separated by the inlet port and the outlet port, thereby an airflow is disturbed in the vicinity of the openings.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary plan view showing a HDD according to a first embodiment of the present invention by removing a top cover therefrom;

FIG. 2 is an exemplary perspective view showing a circulation filter portion of the HDD;

FIG. 3 is an exemplary sectional view of the HDD taken along line III-III of FIG. 1;

FIG. 4 is an exemplary sectional view showing a HDD according to a second embodiment of the present invention; and

FIG. 5 is an exemplary plan view showing a HDD according to a third embodiment of the present invention.

### DETAILED DESCRIPTION

Various embodiments according to the invention will be described hereinafter with reference to the accompanying drawings. In general, according to one embodiment of the invention, a disk drive apparatus comprising: a case having a base including a rectangular bottom wall and a sidewall standing along a peripheral edge of the bottom wall; a drive motor provided on the bottom wall of the base; a disk-shaped recording medium supported and rotated by the drive motor; a head configured to perform information processing to the recording medium; a carriage movably supporting the head with respect to the recording medium; and a circulation filter arranged at a corner located downstream of the head with respect to the rotating direction of the recording medium of the corners of the bottom wall, the sidewall of the base having a confronting surface which continuously extends along the outer peripheral edge of the recording medium, is formed in an arc, and confronts with an outer peripheral edge of the recording medium with a gap, and the base having a guide flow path, which is formed in the sidewall at the corner and guides an airflow to the circulation filter, the guide flow path having an inlet port and an outlet port which open to the confronting surface of the sidewall in the corner, respectively, and the inlet port and the outlet port opening to the confronting surface at positions away from the positions at which they confront with the outer peripheral edge of the recording medium.

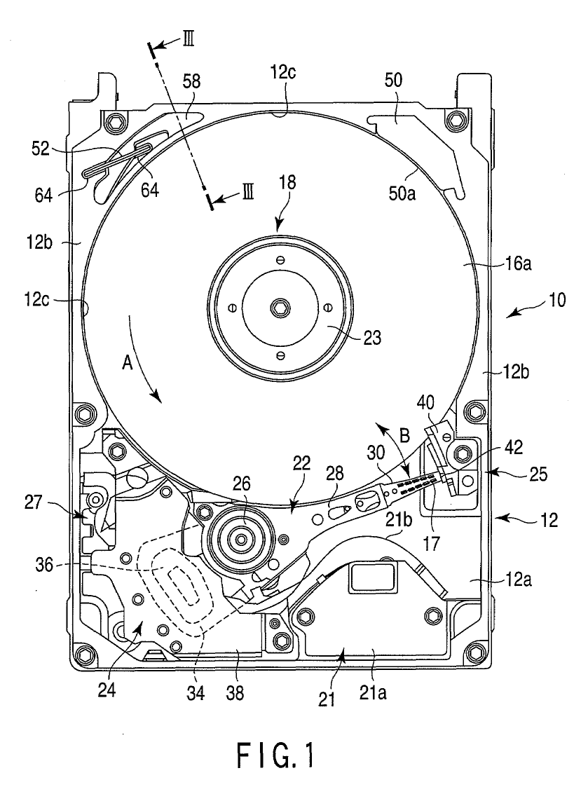

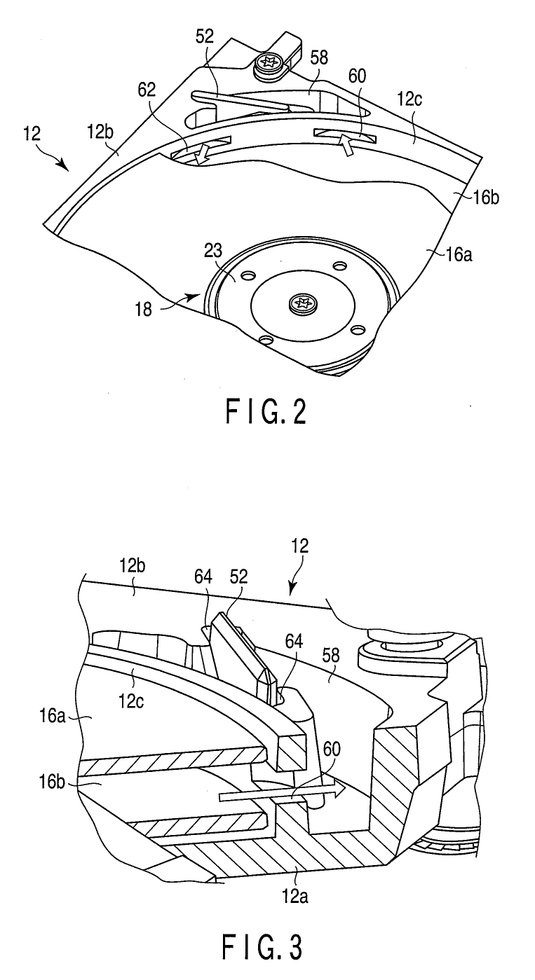

A HDD according to a first embodiment of the present invention will be explained in detail referring to the drawings. FIG. I shows an internal structure of the HDD by removing a top cover therefrom, FIG. 2 shows one corner of a case in enlargement, and FIG. 3 shows a cross section of the HDD taken along line III-III of FIG. 1.

As shown in FIG. 1 the HDD includes a case 10. The case 10 has a rectangular box-shaped base 12 with an open upper surface and the not shown top cover fixed to the base by a plurality of screws and closing the opening of the upper end surface of the base. The base 12 has a rectangular bottom wall 12a and a sidewall 12b standing around the peripheral edge of the bottom wall. The base 12 is formed integrally by die-casting metal such as iron and the like.

A spindle motor 18 acting as a drive motor mounted on the bottom wall 12a of the base 12 and two magnetic disks 16a, 16b (only an upper magnetic disk is shown in FIG. 1) supported and rotated by the spindle motor are disposed in the case 10. Further, in the case 10 are arranged a plurality of magnetic heads 17 for recording and reproducing information to and from the magnetic disks 16, a carriage assembly 22 for movably supporting these magnetic heads with respect to the magnetic disks 16, a voice coil motor (VCM) 24 for pivoting and positioning the carriage assembly, a ramp load mechanism 25 for holding the magnetic heads at an retracted position away from the magnetic disks when the magnetic heads move to the outermost peripheries of the magnetic disks, an inertia latch mechanism 27 for holding the carriage assembly at the retracted position when a shock and the like act on the HDD, and a board unit 21 having a preamplifier and the like, and these components are accommodated in the case 10.

A not shown printed circuit board is fixed to the outside surface of the bottom wall 12a of the base 12 by screws. The printed circuit board controls the operations of the spindle motor 18, the VCM 24, and the magnetic heads through the board unit 21.

As shown in FIGS. 1 to 3, the respective magnetic disks 16a, 16b are formed in, for example, a diameter of 65 mm (2.5 inches) and have magnetic recording layers on the upper and lower surfaces thereof. The two magnetic disks 16a, 16b are coaxially engaged with a hub (not shown) of the spindle motor 18 each other and stacked with a gap. The magnetic disks 16a, 16b are cramped by a cramp spring 23 and fixed to the hub. With this arrangement, the magnetic disks 16a, 16b are supported in the state that they are positioned in parallel with the bottom wall 12a of the base 12. Then, the magnetic disks 16a, 16b are rotated in the direction of an arrow A by the spindle motor 18 at a predetermined speed of, for example, 5400 rpm or 7200 rpm.

That part of the sidewall 12b, which is located in approximately the half of the region of the base 12 in the longitudinal direction thereof, is located so as to surround the outer peripheral edges of the magnetic disks 16a, 16b. The sidewall 12b has a confronting surface 12c standing substantially perpendicular to the bottom wall 12a, and the confronting surface 12c is formed in an arc continuously extending along the outer peripheral edges of the magnetic disks 16a, 16b and confront with the outer peripheral edges of the magnetic disks with a minute gap. With this arrangement, the sidewall 12b having the confronting surface 12c constitutes a shroud with respect to the magnetic disks 16a, 16b.

As shown in FIG. 1, the carriage assembly 22 has a bearing unit 26 fixed on the bottom wall 12a of the base 12 and four arms 28 extending from the bearing unit. The bearing unit 26 is located at a position away from the center of rotation of the magnetic disks 16a, 16b in the longitudinal direction of the base 12 and in the vicinity of the outer peripheral edges of the magnetic disks. The four arms 28 are located in parallel with the surfaces of the magnetic disks 16a, 16b at a predetermined gap therebetween and extend from the bearing unit 26 in the same direction. The carriage assembly 22 has elastically deformable elongate plate-shaped suspensions 30. The suspensions 30 are formed of a plate spring and have base ends fixed to the extreme ends of the arms 28 by spot welding or adhesion and extending from the arms. Note that the respective suspensions 30 may be formed integrally with the arms 28 corresponding thereto.

The magnetic heads 17 are mounted on the extending ends of the suspensions 30. Each of the magnetic heads 17 has an approximately rectangular slider and a recording/reproducing MR (magneto-resistive) head formed on the slider and is supported on the distal end of the suspension 30 through a gimbal. Each two magnetic heads of the four magnetic heads 17, which are mounted on the suspensions 30, are located to face each other, respectively and disposed so as to cramp the respective magnetic disks from both the surfaces thereof.

The carriage assembly 22 has a support frame 34 extending from the bearing unit 26 in a direction opposite to the arms 28, and a voice coil 36 constituting a part of the VCM 24 is supported by the support frame. The support frame 34 is formed of a synthetic resin to the outer periphery of the voice coil 36 integrally therewith. The voice coil 36 is located between a pair of yokes 38 fixed on the base 12 and constitutes the VCM 24 together with these yokes and a magnet (not shown) fixed to one of the yokes.

When power is supplied to the voice coil 36, the carriage assembly 22 is pivoted around the bearing unit 26 in the direction of an arrow B, and the magnetic heads 17 are moved onto and positioned on desired tracks of the magnetic disks 16a, 16b. With this operation, the magnetic heads 17 can write or read out information to and from the magnetic disks 16. The carriage assembly 22 and the VCM 24 constitute a head actuator.

The ramp load mechanism 25 has a ramp 40, which is located on the bottom wall 12a of the base 12 and arranged outside of the magnetic disks 16a, 16b, and tabs 42 extending from distal ends of the respective suspensions 30. The ramp 40 is located downstream of the bearing unit 26 with respect to a rotating direction A of the magnetic disks 16a, 16b. When the carriage assembly 22 is pivoted and the magnetic heads 17 are moved to the retracted position outside of the magnetic disks 16a, 16b, the respective tabs 42 are engaged with a ramp surface formed on the ramp 40 and thereafter pulled upward along the inclination of the ramp surface to thereby unload the magnetic heads 17.

The board unit 21 has a main body 21a formed of the flexible printed circuit board, and the main body 21a is fixed on the bottom wall 12a of the base 12. Electronic components such as a head amplifier and the like are mounted on the main body 21a. The board unit 21 has a main flexible printed circuit board (main FPC) 21b extending from the main body 21a. The extended end of the main FPC 21b is connected to the vicinity of the bearing unit 26 of the carriage assembly 22 and further electrically connected to the magnetic heads 17 through cables (not shown) disposed on the arms 28 and the suspensions 30. A connector, not shown, is mounted on the bottom surface of the main body 21a of the board unit 21 and it is connected to the printed circuit board.

The HDD has a breathing filter 50 for removing the dust, moisture, and gas components contained in the external air flowing into the case through a ventilation hole formed in the top cover or the base 12, and a circulation filter 52 for capturing the dust produced in the case by the operation of moving components. The breathing filter 50 and the circulation filter 52 are disposed around the magnetic disks 16.

The breathing filter 50 is arranged at the corner nearest to the magnetic heads 17 or the ramp 40 downward thereof of the corners of the base 12 with respect to the rotating direction A of the magnetic disks 16a, 16b. The breathing filter 50 has an arcuate outside surface 50a which is positioned to face the confronting surface 12c of the sidewall 12b of the base 12.

As shown in FIGS. 1 to 3, the circulation filter 52 is formed in, for example, a rectangular mat state and arranged at the corner nearest to the breathing filter 50 downward thereof of the corners of the base 12 with respect to the rotating direction A of the magnetic disks 16a, 16b.

The base 12 has a guide flow path 58 for guiding an airflow to the circulation filter 52 formed in the sidewall 12b in the above corner. The guide flow path 58 extends tangentially or in an arc with respect to the magnetic disks 16a, 16b. The guide flow path 58 has an inlet port 60 and an outlet port 62 which open to the confronting surface 12c of the sidewall 12b, respectively in the corner of the base 12. The inlet port 60 communicates with the guide flow path 58 on the upstream end thereof, and the outlet port 62 communicates with the guide flow path on the downstream end thereof. The inlet port 60 and outlet port 62 open to the confronting surface 12c of the sidewall 12b at positions away from the positions where they confront with the outer peripheral edges of the magnetic disks 16a, 16b. Further, the inlet port 60 and the outlet port 62 are disposed away from each other along the rotating direction of the magnetic disk 16a.

The inlet port 60 and the outlet port 62 are formed in a slender and rectangular shape, respectively, extend along the circumferential direction of the magnetic disks and are formed at the positions as high as the bottom wall 12a of the base 12. According to the first embodiment, the inlet port 60 and the outlet port 62 of the guide flow path 58 open to the confronting surface 12c of the sidewall 12b, respectively at positions confronting with the gap between the two magnetic disks 16a, 16b.

The circulation filter 52 is disposed in the guide flow path 58 so as to close it. The circulation filter 52 is held at a predetermined position in the state that the both ends thereof are engaged with a slit 64 formed to the sidewall 12b.

According to the HDD arranged as described above, when the magnetic disks 16a, 16b rotate at high speed, an airflow is produced along the rotating direction thereof. The airflow is made to a laminar flow by the confronting surface 12c of the sidewall 12b confronting with the outer peripheral edges of the magnetic disks 16a, 16b at the minute gap and then flows along the direction of arrow A. Further, a part of the airflow flows from the inlet port 60 into the guide flow path 58 and flows tangentially over the magnetic disks 16a, 16b in the guide flow path. The airflow passes through the circulation filter 52, and the dust contained in the airflow is captured by the circulation filter 52. Thereafter, the airflow is returned in the direction of the magnetic disks 16a, 16b from the outlet port 62 and joined to the airflow flowing along the outer peripheral edges of the magnetic disks.

The inlet port 60 and the outlet port 62 of the guide flow path 58 open to the confronting surface 12c of the sidewall 12b at positions away from the positions at which they confront with the outer peripheral edges of the magnetic disks 16a, 16b. Accordingly, the portion of the confronting surface 12c, which confronts with the outer peripheral edges of the magnetic disks 16a, 16b, is not separated by the inlet port 60 and the outlet port 62 and form the shroud that continuously extends along the outer peripheral edges of the magnetic disks. With this arrangement, since no disturbance of airflow is produced in the inlet port 60 and the outlet port 62 of the guide flow path 58, the airflow is made to the laminar flow by the confronting surface 12c, thereby the production of a turbulent flow is suppressed. Accordingly, the disk flutter can be suppressed while maintaining the capturing efficiency of particles of the circulation filter 52. Further, since the confronting surface 12c of the sidewall 12b that constitutes the shroud is formed integrally with the base 12, a shroud structure can be obtained by simple processing of forming the inlet port and the outlet port to the confronting surface.

With the arrangement described above, even if the magnetic disks 16a, 16b rotate at high speed, the disk flutter caused by the turbulence of airflow can be reduced by making the airflow produced in vicinity of the magnetic disks to the laminar flow. Further, the wind disturbance impinged on the suspensions 30 of the carriage assembly 22 can be suppressed. With this arrangement, vibration of the magnetic disks caused by the wind disturbance can be reduced and the displacement of the suspensions due to the disturbance can be reduced, thereby the positioning accuracy of the magnetic heads with respect to magnetic disks can be improved. As a result, it is possible to narrow the track pitch of the magnetic disks and to increase a memory capacity and the angular velocity of the magnetic disks, thereby a magnetic disk apparatus having a high performance can be obtained.

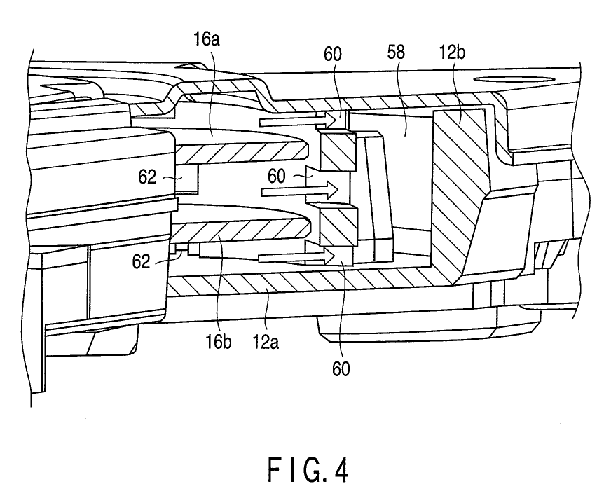

Next, a HDD according to a second embodiment will be explained. FIG. 4 is a sectional view showing a part of the HDD according to the second embodiment in cross section. As shown in the drawing, the guide flow path 58 is formed to the sidewall 12b in a corner of the base 12, and the circulation filter is disposed in the guide flow path. The guide flow path 58 has a plurality of, for example, three inlet ports 60 and three outlet ports 62.

The three inlet ports 60 open to the confronting surface 12c of the sidewall 12b at positions away from the positions where they confront with the outer peripheral edges of the magnetic disks 16a, 16b, respectively. The three inlet ports 60 are arranged at gaps along the axial direction of the magnetic disks 16a, 16. The inlet port 60 interposed between the remaining two inlet ports 60 opens to the confronting surface 12c of the sidewall 12b at a position confronting the gap between the magnetic disks 16a, 16b, the upper inlet port 60 opens to the confronting surface 12c at a position confronting with the space on the upper surface side of the upper magnetic disk 16a and further the lower inlet port 60 opens to the confronting surface 12c at a position confronting with the space on the lower surface side of the lower magnetic disk 16b.

Likewise, the three outlet ports 62 open to the confronting surface 12c of the sidewall 12b at positions away from the positions at which they confront with the outer peripheral edges of the magnetic disks 16a, 16b, respectively. These three outlet ports 62 are disposed at gaps in the axial direction of the magnetic disks 16a, 16b. The outlet port 62 interposed between the remaining two outlet ports 62 opens to the confronting surface 12c of the sidewall 12b at a position confronting the gap between the two magnetic disks 16a, 16b, the upper outlet port 62 opens to the confronting surface 12c at the position where it confronts with the space on the upper surface side of the upper magnetic disk 16a, and further the lower outlet port 62 opens to the confronting surface 12c at the position where it confronts with the space on the lower surface of the lower magnetic disk 16b.

In the second embodiment, since the other arrangement is the same as that of the first embodiment described above, the same components are denoted by the same reference numbers and the detailed explanation thereof is omitted. Then, the same operation/working effect as that of the first embodiment described above can be also obtained in the HDD according to the second embodiment.

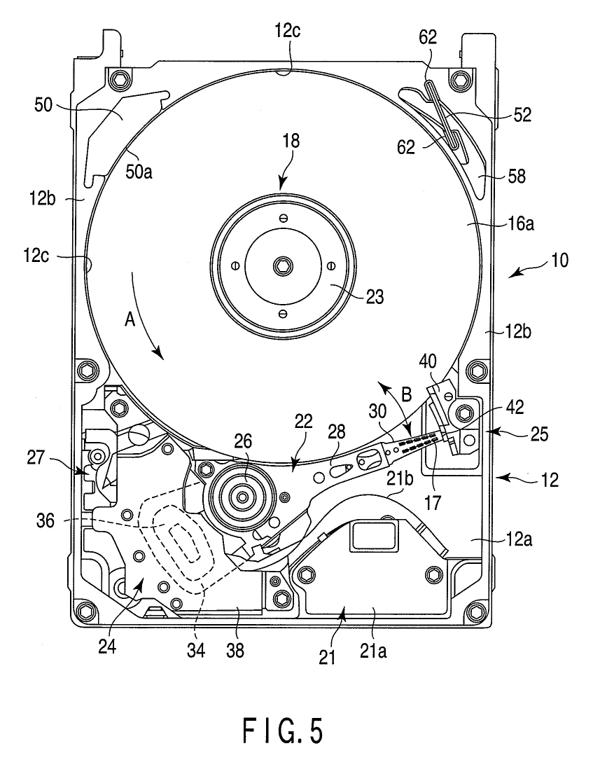

The position at which the circulation filter 52 is disposed may be replaced with the position at which the breathing filter 50 is disposed. That is, as shown in FIG. 5, according to the HDD of the third embodiment, the circulation filter 52 is disposed to the corner nearest to the magnetic heads 17 or the ramp 40 downstream thereof of the corners of the base 12 with respect to the rotating direction A of the magnetic disks 16a, 16b. The guide flow path 58 is formed to the sidewall 12b in the corner of the base 12, and the circulation filter 52 is disposed in the guide flow path. Likewise the embodiment described above, the guide flow path 58 has the inlet port and the outlet port, and the inlet port and the outlet port open to the confronting surface 12c of the sidewall 12b at positions away from the positions at which they confront with the outer peripheral edges of the magnetic disks 16a, 16b.

The breathing filter 50 is located to the corner nearest to the circulation filter 52 downstream thereof of the corners of the base 12 with respect to the rotating direction A of the magnetic disks 16a, 16b. The breathing filter 50 has the arcuate outside surface 50a which is positioned to face the confronting surface 12c of the sidewall 12b of the base 12.

In the third embodiment, since the other arrangement is the same as that of the first embodiment described above, the same components are denoted by the same reference numbers and the detailed explanation thereof will be omitted. The same operation/working effect as that of the first embodiment described above can be also obtained in the HDD according to the third embodiment.

While certain embodiments of the inventions have been described, these embodiments have been presented by way of example only, and are not intended to limit the scope of the inventions. Indeed, the novel methods and systems described herein may be embodied in a variety of forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

For example, although the arrangement in which the two magnetic disks are provided is explained in the embodiment described above, the number of the magnetic disks can be increased when necessary.

What is claimed is:

1. A disk drive apparatus comprising:
a case comprising a base with a rectangular bottom wall and a sidewall standing along a peripheral edge of the bottom wall;
a drive motor provided on the bottom wall of the base;
a recording medium supported and rotated by the drive motor;
a head configured to perform information processing on the recording medium;
a carriage movably supporting the head with respect to the recording medium; and
a circulation filter arranged at a first corner of the bottom wall located downstream of the head with respect to the rotating direction of the recording medium,
wherein the sidewall of the base comprises a confronting surface which extends along the outer peripheral edge of the recording medium, is formed in an arc, and is configured to confront with an outer peripheral edge of the recording medium with a gap, and
the base comprises a guide flow path, which is formed in the sidewall at the corner and is configured to guide an airflow to the circulation filter, the guide flow path comprises an inlet port and an outlet port open to the confronting surface of the sidewall in the corner respectively, and the inlet port and the outlet port are open to the confronting surface at positions away from the positions at which they confront with the outer peripheral edge of the recording medium.

2. The disk drive apparatus of claim 1, wherein the inlet port and the outlet port are formed at positions of the same height with respect to the bottom wall of the base.

3. The disk drive apparatus of claim 1, wherein the guide flow path comprises a plurality of inlet ports and a plurality of outlet ports,
the plurality of inlet ports are open to the confronting surface at positions away from the positions at which they confront with the outer periphery of the recording medium respectively, and the plurality of outlet ports are open to the confronting surface at positions away from the positions at which they confront with the outer periphery of the recording medium respectively.

4. The disk drive apparatus of claim 1, further comprises a plurality of recording mediums stacked with a gap from each other,
wherein the inlet port and the outlet port of the guide flow path confront with the gap between the plurality of recording mediums.

5. The disk drive apparatus of claim 1, further comprises a breathing filter provided at a second corner adjacent to the first corner of the base,
wherein the breathing filter comprises an bow-shaped outside surface positioned in order to face the confronting surface of the sidewall of the base.
